(19) United States
(12) Patent Application Publication
(10) Pub. No.: US 2014/0325349 A1
(43) Pub. Date: Oct. 30, 2014

(54) Real-time Representations of Edited Content

(71) Applicant: ADOBE SYSTEMS INCORPORATED, San Jose, CA (US)

(72) Inventors: Tim Riot Riherd, San Francisco, CA (US); Kilian Ciuffolo, Gavardo (IT)

(73) Assignee: Adobe Systems Incorporated, San Jose, CA (US)

(21) Appl. No.: 13/874,061

(22) Filed: Apr. 30, 2013

(51) Int. Cl. G06F 17/24

(52) U.S. Cl. CPC G06F 17/24
USPC 715/255

(57) ABSTRACT

Real-time representations of edited content are described. In one or more embodiments, a content editing application makes use of a generator module to convert content files substantially in real-time between a input format used for design and an output format used to represent content. The generator module is operable to detect data that describes changes to content files produced using a source application. The generator module then coverts content files from the input format into the output format. The conversion may occur substantially in real-time as the image files are being edited so that the designer may see changes to a representation of the output as the designer makes edits. In at least some embodiments, edited source content files in an application-specific design format are represented as script-based objects as changes are made and the script-based objects are then converted into HTML5 or another designated format for rendering.

### BACKGROUND

Individuals have increasing access to and make frequent use of content editing applications available from service providers to produce and edit content. For example, image editing software may be employed to manipulate digital pictures, create artwork projects, publish content, and so forth. Today, web designers and other users often develop content they intend to publish as webpages or other web-based content. Publishing of content for the web may involve conversion of content files between an application-specific source format (e.g., a proprietary format of content editing software) used for design into a target output format designated for content rendering (e.g., HTML5/CSS, XML, and/or other designated format). Traditionally, the conversion process occurs separately from content design/editing. In this approach, content is developed and then after a project is completed, the user may select an output format and initiate conversion to a target output format. Accordingly, it may be difficult during design for the content designer to know how the output content will ultimately appear in the published format. Additionally, little or no feedback is provided to enable the content designer to understand tools available in the design environment and how the tools relate to capabilities in the output format.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Various embodiments provide real-time representations of edited content. In one or more embodiments, a content editing application includes or makes use of a generator module configured to convert content files substantially in real-time between a input format used for design and an output format used to represent content. In one approach, the generator module is operable to detect data that describes changes to content files produced using a source application. The generator module may then covert content files from the input format into the output format. For example, image files in an application-specific format for editing may be converted into an HTML5 representation that is renderable by a browser. The conversion may occur substantially in real-time as the image files are being edited so that the designer may see changes to the HTML5 representation as the designer makes edits. In at least some embodiments, edited source content files are represented using script-based objects as changes are made and the script-based objects are then converted into HTML5 (or another designated format) for rendering.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 illustrates an example scenario in which files are converted between formats in accordance with one or more implementations.

FIG. 3 illustrates another example scenario in which files are converted between formats in accordance with one or more implementations.

FIG. 4 illustrates another example scenario in which files are converted bi-directionally between formats in accordance with one or more implementations.

FIG. 5 illustrates another example scenario in which files associated with multiple source applications are converted between formats in accordance with one or more implementations.

FIG. 6 is a flow diagram depicting an example procedure in accordance with one or more implementations.

FIG. 7 is another flow diagram depicting an example procedure in accordance with one or more implementations.

FIG. 8 illustrates an example system including various components of an example device that can be employed for one or more implementations of real-time representations of edited content described herein.

### DETAILED DESCRIPTION

### Overview

Traditionally, processes for designing content and exporting content to a target format are bifurcated. Thus, for instance, a web designer may not be able to determine how web content will be represented in a particular rendering environment until after the project design is completed and files are exported.

Various embodiments provide real-time representations of edited content. In one or more embodiments, a content editing application includes or makes use of a generator module configured to convert content files substantially in real-time between a input format used for design and an output format used to represent content. In one approach, the generator module is operable to detect data that describes changes to content files produced using a source application. The generator module may then covert content files from the input format into the output format. For example, image files in an application-specific format for editing may be converted into an HTML5 representation that is renderable by a browser. The conversion may occur substantially in real-time as the image files are being edited so that the designer may see changes to the HTML5 representation as the designer makes edits. Here, the term “real-time” is intended to indicate that editing of underlying content files and refreshing and/or re-rendering of representations of converted content for display via a browser (or other suitable target application) may appear to occur substantially simultaneously to a viewer and/or without a visually perceptible delay.

In at least some embodiments, edited source content files are represented using script-based objects as changes are made and the script-based objects are then converted into HTML5 or another designated format for rendering. By way of example and not limitation, the techniques may rely upon a node.js server to establish a connection to a source application(s). As changes are made to underlying source content, source content and changes thereto may be represented using JavaScript Object Notation (JSON) objects or another suitable intermediate format. These JSON objects are then converted into a selected output/target format to update the content representation. The representation may be displayed in real-time via a browser or other application capable of rendering the converted content files. Thus, the developer/user is provided with real-time representations of edited content that are viewable in a target rendering environment as changes are being made.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

Example Environment

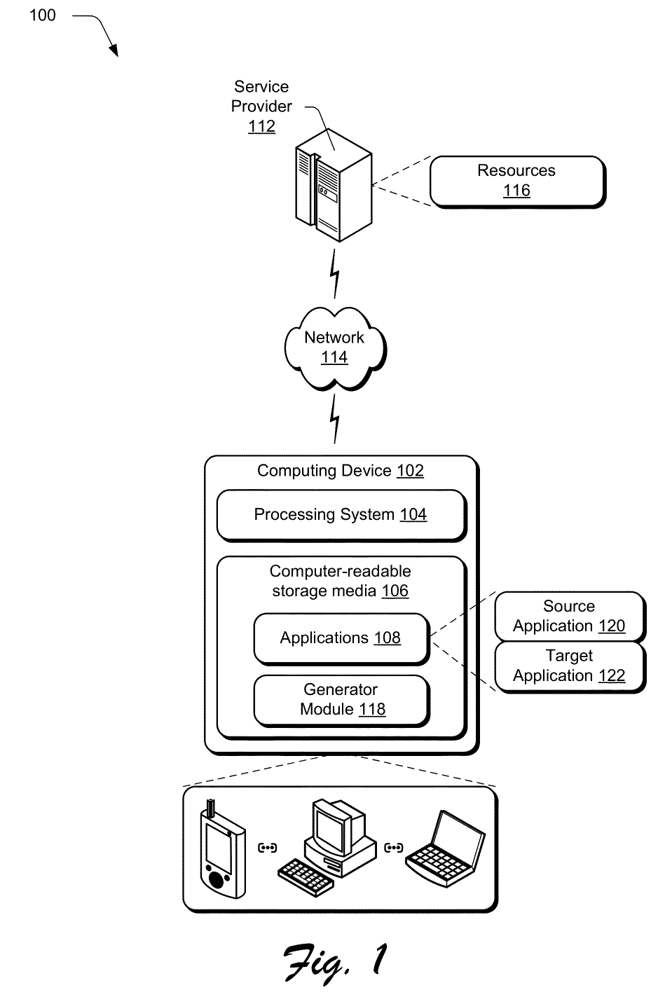

FIG. 1 is an illustration of an environment 100 in an example implementation that is operable to employ techniques described herein. The illustrated environment 100 includes a computing device 102 including a processing system 104 that may include one or more processing devices, one or more computer-readable storage media 106, and various applications 108 embodied on the computer-readable storage media 106 and operable via the processing system 104 to implement corresponding functionality described herein. In at least some embodiments, applications 108 may include a browser of the computing device operable to access various kinds of web-based resources (e.g., content and services). The applications 108 may also represent a client-side component having integrated functionality operable to access web-based resources (e.g., a network-enabled application), browse the Internet, interact with online providers, and so forth. Applications 108 may further include an operating system for the computing device and other device applications.

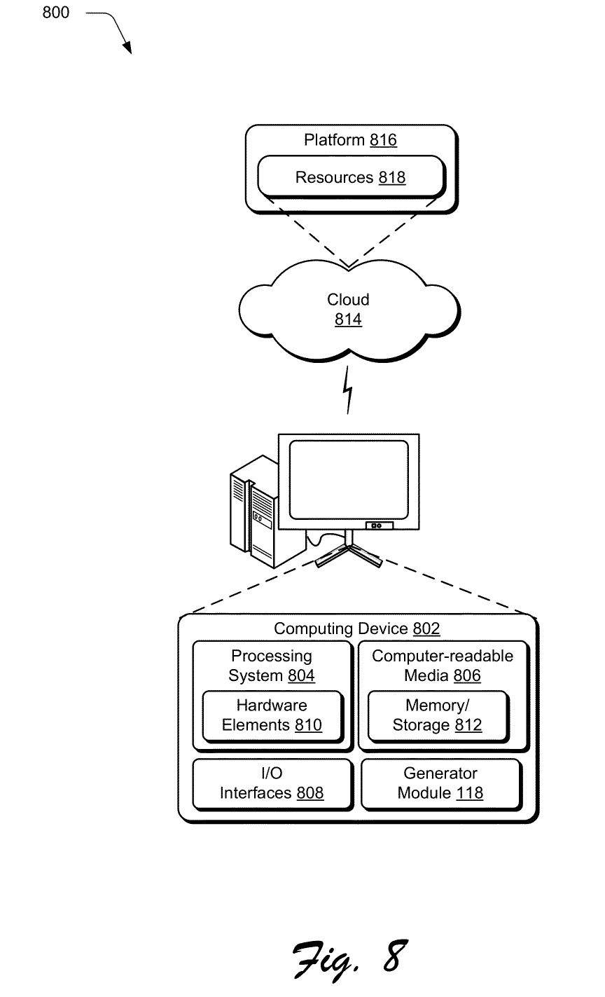

The computing device 102 may be configured as any suitable type of computing device. For example, the computing device may be configured as a desktop computer, a laptop computer, a mobile device (e.g., assuming a handheld configuration such as a tablet or mobile phone), a tablet, and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 8.

The environment 100 further depicts one or more service providers 112, configured to communicate with computing device 102 over a network 114, such as the Internet, to provide a “cloud-based” computing environment. Generally, speaking a service provider 112 is configured to make various resources 116 available over the network 114 to clients. In some scenarios, users may sign up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services and/or content typically made available over a network by one or more providers. Some examples of services include, but are not limited to, a photo editing service, a web development and management service, a collaboration service, a social networking service, a messaging service, an advertisement service, and so forth. Content may include various combinations of text, video, ads, audio, multi-media streams, animations, images, web documents, web pages, applications, device applications, and the like.

The computing device 102 may also include or make use of a generator module 118 that represents functionality operable to implement real-time representations of edited content as described herein. For example, the generator module 118 may be configured in various ways to facilitate conversions of content files between respective formats for a source application 120 and a target application 122. To do so, the generator module 118 may be configured to make use of plug-ins for various individual applications 108. The plug-ins provides extensibility for users to adapt and make use of the generator module 118 with many different sources formats and target formats. Conversions may occur bi-directionally between selected formats. Additionally, content from multiple different source applications may be combined into a combined content representation in some scenarios.

The generator module 118 may be implemented as a software module, a hardware device, or using a combination of software, hardware, firmware, fixed logic circuitry, etc. Further, the generator module 118 may be implemented as a standalone component of the computing device 102 as illustrated. In addition or alternatively, the generator module 118 may be configured as a component of an application 108, an operating system, or other device application.

In at least some embodiments, the generator module 118 is configured to operate in connection with content editing applications that may use application-specific and/or proprietary formats. By way of example and not limitation, the source application 120 may be configured as an image editor application one example of which is Adobe Photoshop™. Other content and image editor applications are also contemplated. The generator module 118 may further support dynamic scripting languages and web standards used to represent content, such as JavaScript, hypertext markup language revision 5 and cascading style sheets (HTML5/CSS), extensible mark-up language (XML) and/or extensible application mark-up language (XAML) through corresponding plug-ins. Thus, the target application 122 may be a browser or network-enabled application used to represent webpages, documents, and other web-based content. In one particular example, the generator module 118 is configured to convert files between a .psd format employed by Adobe Photoshop™ and an HTML5 representation that is renderable by a browser. Other examples and combinations of formats are also contemplated.

Having considered an example environment, consider now a discussion of some example details of the techniques for real-time representations of edited content in accordance with one or more implementations.

Real-Time Representation of Edited Content Details

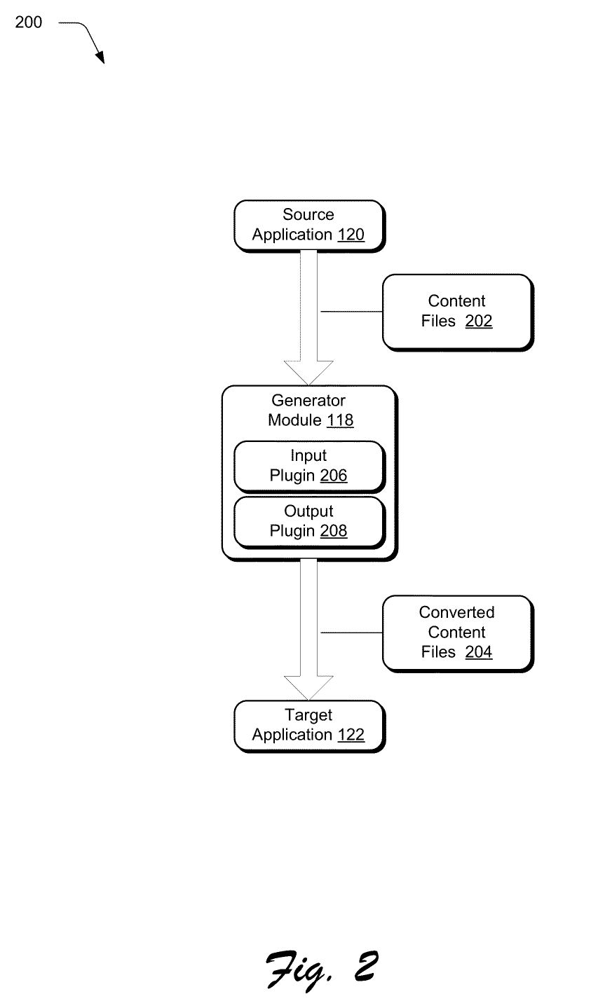

This section describes some example details of real-time representations of edited content in accordance with one or more implementations. FIG. 2 depicts generally at 200 an example scenario in which files are converted between formats to enable real-time representations. For example, a user may then interact with a source application 120 in various ways to produce or edit content files 202 in a source format. When this occurs, the generator module 118 may be configured to detect changes that are made to the content files 202 and operates to produce converted content files 204 associated with a target application 122.

In general, an input plugin 206 of the generator module 118 may be implemented to establish a connection to the source application 120. The input plugin 206 may recognize files in a format of the source application and handle conversions of the files to a designated intermediate format supported by the generator module 118. Likewise, an output plugin 208 of the generator module 118 may be implemented to establish a connection to the target application 122. The output plugin 208 may be configured to recognize files in the intermediate format and convert the files into a target format that is appropriate for the target application 122.

Generally, the intermediate format may be any suitable format that facilitates conversions between source and target formats. The intermediate format may be selected as a platform independent script-based format from which mark-up language for content pages/documents may be derived. The intermediate format is used to set-up an internal representation of the content used by the generator module 118 to facilitate conversions. As mentioned, JSON is one example of such a format although different intermediate formats are also contemplated. Thus, changes made to underlying source content files may be converted into the intermediate format and subsequently converted into a suitable mark-up language format for rendering. In some implementations, the described process may also work in the reverse direction. Thus, changes made to a rendered document having a mark-up language format (or other representation format) may be converted into the intermediate format and subsequently converted into an application specific and/or proprietary format associated with a source application 120. In this case, the input plugin 206 and output plugin 208 may each be configured to handle conversions to and from the intermediate format for the source application 120 and target application 122 respectively.

Various plugins may be employed to provide functionality for conversions between different source and target formats associated with corresponding applications. The plugins may be configured in various ways. In one approach, a plugin may be configured as a virtual server that subscribes to and/or monitors notifications regarding changes to content from an underlying application. The virtual server therefore is configured to establish a connection to a corresponding application, detect when changes to content are made via the application, and update files that represent the content to reflect the changes accordingly. In at least some implementations, the virtual server is a node.js server that is configured to perform conversions between formats using JSON objects to represent underlying content. In addition or alternatively, one or more plugins may be implemented as application programming interfaces (APIs) that are designed to detect and handle changes to content via a corresponding application in a comparable manner.

Converted content files 204 may be stored and/or published to make the files accessible in real time. For example, converted content files 204 may be stored locally on a computing device and may be updated as changes are made using the source application 120. The converted content files 204 may also be published to a web accessible location such as storing the files on cloud-based storage, posting to a web site location, or synchronizing files associated with a collaborative session via an online collaboration service. In one particular example, converted content files 204 are associated with a uniform resource locator (URL) indicative of a location at which the files are available. A browser or other suitable target application 122 may navigate to the URL to render the corresponding files. Thus, as a user makes changes via the source application 120, a “real-time” representation that reflects the changes may be rendered and viewed using a target application 122 (e.g., browser) that is pointed to the URL associated with the converted content files 204 produced via the generator module 118. Here, the URL may correspond to local storage, cloud-based or network storage, a particular website, an interactive/collaborative session via an online provider, and so forth.

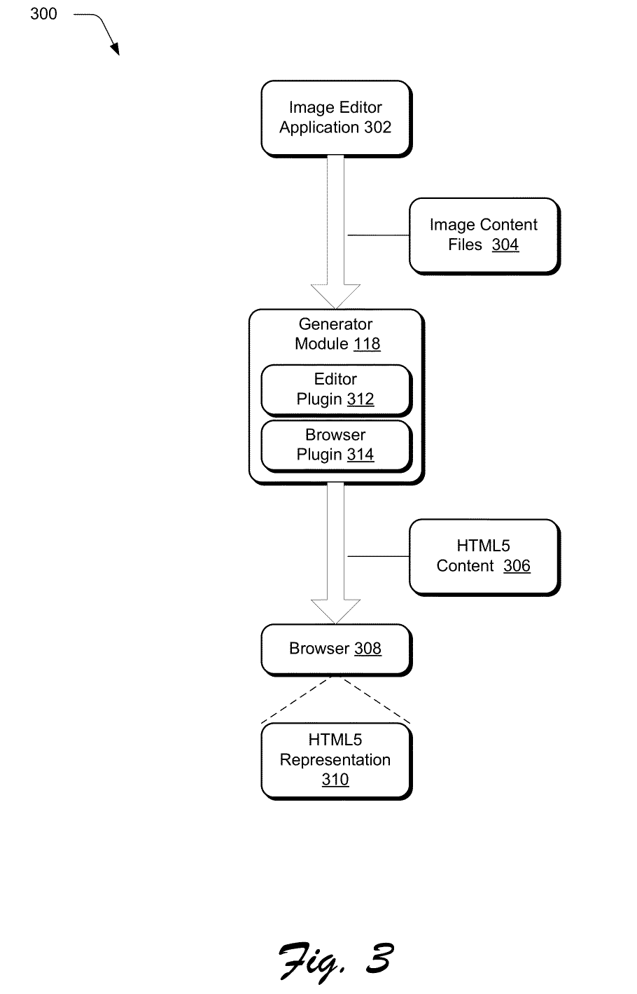

FIG. 3 depicts generally at 300 an example scenario in which a real time HTML5 representation is generated from underlying image content files for an image editing application. In particular, an image editor application 302 is depicted that may be operable to create, manipulate, and manage image content files 304 in various ways. The image editor application 302 represents functionality to create image based content including but not limited to applying special effects and filters, combining images, animation, touch-ups, lighting enhancement, insertion of graphic/textual overlays, and so forth.

The generator module 118 may operate to convert the image content files 304 associated with the image editor application 302 to HTML5 content 306 that may be rendered by way of a browser 308 to output an HTML5 representation 310 of the content. In accordance with techniques described herein, this may occur substantially in real time as changes are made to the image content files 304 via the image editor application 302. In order to do so, the generator module 118 may include or make use of an editor plugin 312 that corresponds to the image editor application 302 and a browser plugin 314 that corresponds to the browser 308. These plugins are configured to handle format conversions between formats for the image editor application 302 and browser 308 through a designated intermediate format as discussed herein.

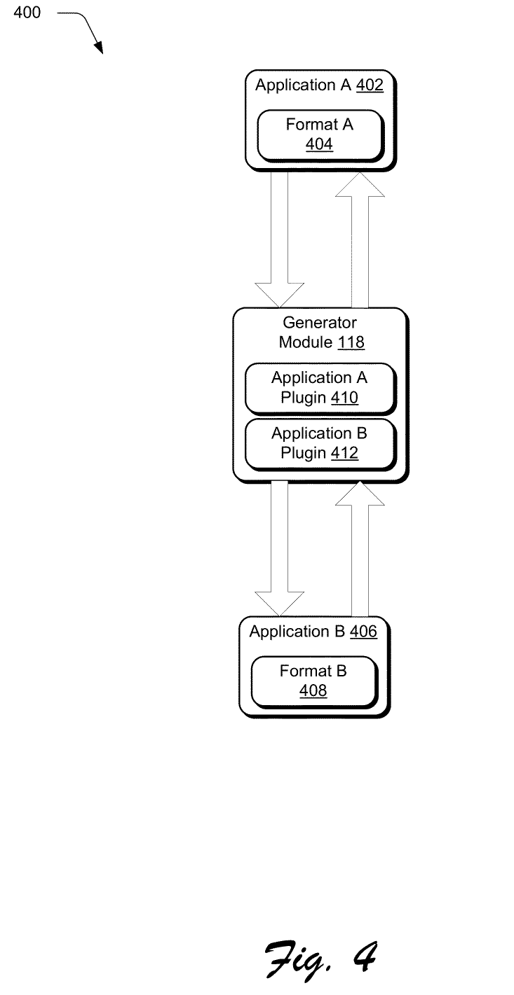

FIG. 4 depicts generally at 400 an example scenario in which a real time bi-directional conversion between formats may occur via a generator module. In particular, conversions may occur back and forth between an Application A 402 that uses a Format A 404 and An application B 406 that uses a Format B 408. In this example, the generator module 118 includes an Application A Plugin 410 corresponding Application A 402 and an Application B Plugin 412 corresponding to Application B 406 that operate to perform conversions into and out of an intermediate format. Thus, FIG. 4 represents the notion that conversions between formats may occur and be reflected in real time bi-directionally between applications and corresponding formats using the generator module 118 and appropriate plugins.

By way of example, changes made via a representation in browser may be reflected back to underlying source files for an image editor application and displayed via an interface for the image editor application. In addition, changes made via the image editor application may be presented via the browser in real-time as previously described. Accordingly, if a user opens windows for an image editor application and a browser (e.g., side-by-side windows), changes made via one application window will automatically be reflected in the other application window in real time as the changes are being made. Here, the generator module may use appropriate plugins to establish a bi-lateral communication connection between multiple applications that enables real-time representations of changes to be presented back and forth between the multiple applications.

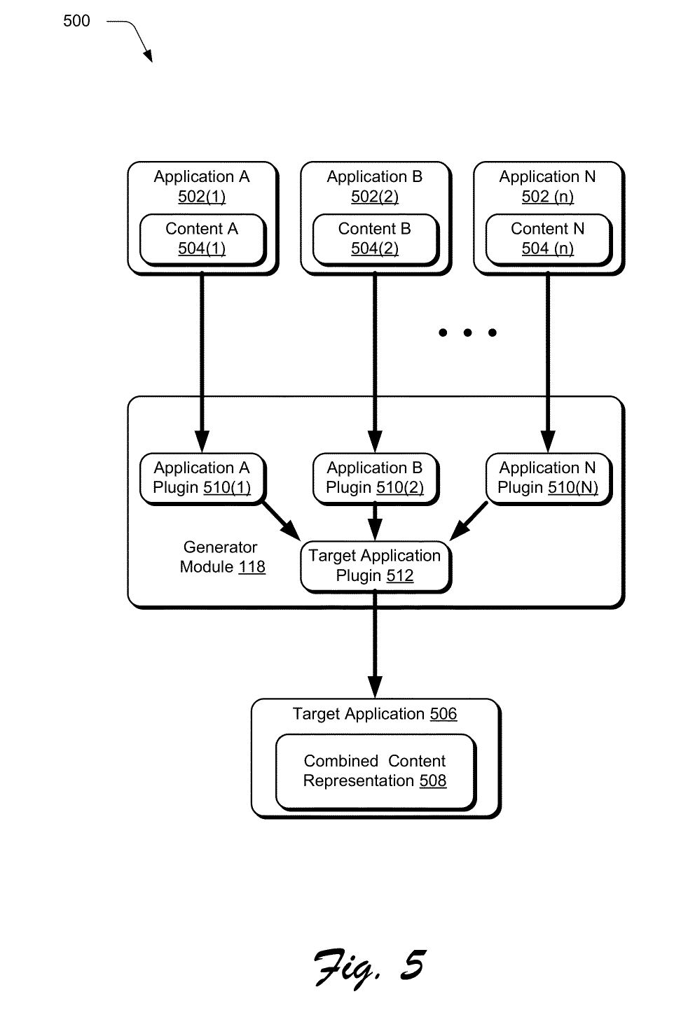

FIG. 5 depicts generally at 500 an example scenario in which content from multiple source applications may be converted to produce a combined content representation. Here, multiple applications 502(1)-502(n) that have respected content 504(1)-504(n) are represented. The content 504(1)-504(n) associated with different applications may use different formats. In this example, the generator module 118 may operate to convert the content 504(1)-504(n) from multiple applications into a format associated with a target application 506. Then, a combined content representation 508 may be output via the target application. In order to do so, the generator module 118 make include or make use of plugins 510(1)-510(n) that correspond to each of the individual applications 502(1)-502(n). Here, the plugins 510(1)-510(n) operate to convert between formats associated with the individual applications and an intermediate format. The generator module 118 may further include a target application plugin 512 configured to handle the conversion from the intermediate format to a format for the target application 506. In this way, a combined content representation 508 may be produced from underlying content associated with multiple individual applications.

This approach may be employed with composite documents that include embedded or linked content associated with various native applications. For instance, a suite of design applications that provide integrated development tools may be employed to create a composite project. The project may rely upon multiple underlying applications and have different content formats. The generator module 118 may be operable to convert content for each of the applications using respective plugins and thereby create the combined content representation 508.

Having discussed example details of the techniques for real-time representations of edited content, consider now some example procedures to illustrate additional aspects of the techniques.

Example Procedures

This section describes example procedures for real-time representations of edited content in one or more implementations. Aspects of the procedures may be implemented in hardware, firmware, or software, or a combination thereof. The procedures is shown as a set of blocks that specify operations performed by one or more devices and are not necessarily limited to the orders shown for performing the operations by the respective blocks. In at least some embodiments the procedures may be performed by a suitably configured device, such as the example computing device 102 of FIG. 1 that makes use of a generator module 118.

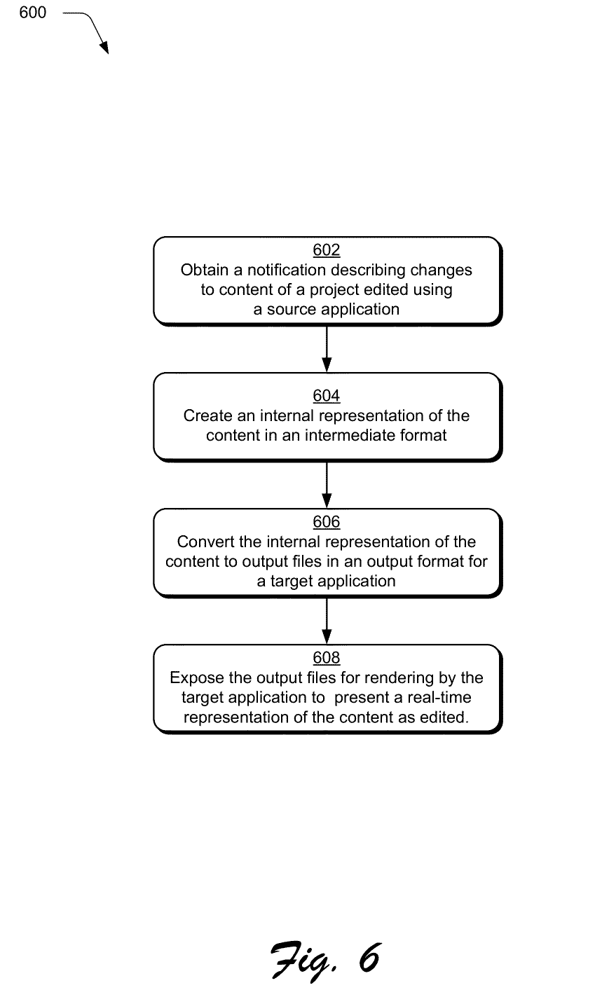

FIG. 6 depicts an example procedure 600 in which changes to content may be represented substantially real-time. A notification is obtained describing changes to content of a project edited using a source application (block 602). For example, a generator module 118 may be configured to enable a connection to a source application in various ways. A variety of source applications are contemplated as described herein. Moreover, in at least some implementations content from multiple underlying source applications may be converted and represented in real-time. Thus, the project may represent a document associated with a single application or a composite document that includes linked or embedded content associated with multiple applications and/or a suite of design applications.

Through the connection, the generator module 118 may be configured to obtain notifications regarding changes to content for a project in various ways. In one approach, the generator module 118 is operable to subscribe to notifications from the source application(s) or otherwise register to receive such notifications when changes to content occur. In addition or alternatively, the generator module 118 may be configured to poll the application periodically to obtain the updates.

In one particular example, the generator module 118 may be configured as a node.js server that operates independently of the source applications and/or target applications. The node.js server may be a virtual server that is implemented locally at a device to act as an intermediary for format conversions between corresponding applications. As noted previously, the generator module 118 may be configured with individual plugins corresponding to each of the applications that the generator module 118 supports. In an example, the notifications are enabled by way of communication connections between applications and the generator module 118 established by the respective plugins. In one approach, the communication connections comprise Transmission Control Protocol/Internet Protocol (TCP/IP) connections to an application programming interface (API) that facilitate various client-server communications including the notifications regarding changes to underlying content. Such communication connections may be established bi-directionally to support bi-directional techniques as described herein with the generator module 118 acting as an intermediary.

The generator module 118 may also be designed using an extensible format that enables developers and third parties to create their own plugins on demand to handle particular applications. Thus, the structure of the generator module 118 provides a great deal of flexibility to set-up real-time representations for one or multiple different source applications with respective source formats that are produced in a selected output format for a target application. In some cases, the output format corresponds to a web content format displayable by a browser. Naturally, other target applications and corresponding output formats are also contemplated.

An internal representation of the content is created in an intermediate format (block 604). As mentioned, the generator module 118 acts as an intermediary and accordingly may handle conversions between input and output formats using a selected intermediate format. Any suitable intermediate format may be employed. In at least some implementations, content for a particular document or project is represented using script-based objects. This may occur using various dynamic scripting languages or mark-up based languages, examples of which were described previously. By way of example and not limitation, the intermediate format may be configured to represent content using Java Script Object Notation (JSON) objects. Other types of script-based objects and formats are also contemplated.

The internal representation of the content is converted to output files in an output format for a target application (block 606). In at least some embodiments the output files are configured as web pages in a mark-up language format. For instance, an HTML5 representation may be produced that include image data, HTML, CSS, and so forth. More generally, the internal representation may be converted to a selected format that corresponds to a target application. In the case of the target application being selected as a browser, the internal representation may be converted to a web content format that is renderable/displayable by the browser. In other examples, the internal representation may be converted to a portable document format associated with a reader application or a word processing format associated with a word processor. The particular input/output formats employed depend upon the applications that are selected as sources and targets and are not limited by the examples set forth herein. Generally, different types of formats for a variety of applications may be supported by including or developing corresponding plugins for the formats/applications.

Then, the output files are exposed for rendering by the target application to present a real-time representation of the content as edited (block 608). This may occur in any suitable way as previously described. For instance, the output files may be associated with a uniform resource locator (URL) that enables the target application to present a real-time representation of the content as edited. In the case of a browser, the browser may point/navigate to the URL. Then, as changes are made to underlying content, a display of the page at the URL by the browser will be updated in real-time to show the changes. The URL may correspond to a local storage location at the computing device. In addition or alternatively, the URL may correspond to cloud-based or network storage, a particular website, an interactive/collaborative session via an online provider, and so forth. Thus, exposing the output files may involve uploading the output files to a network accessible storage location for web-based access in some scenarios.

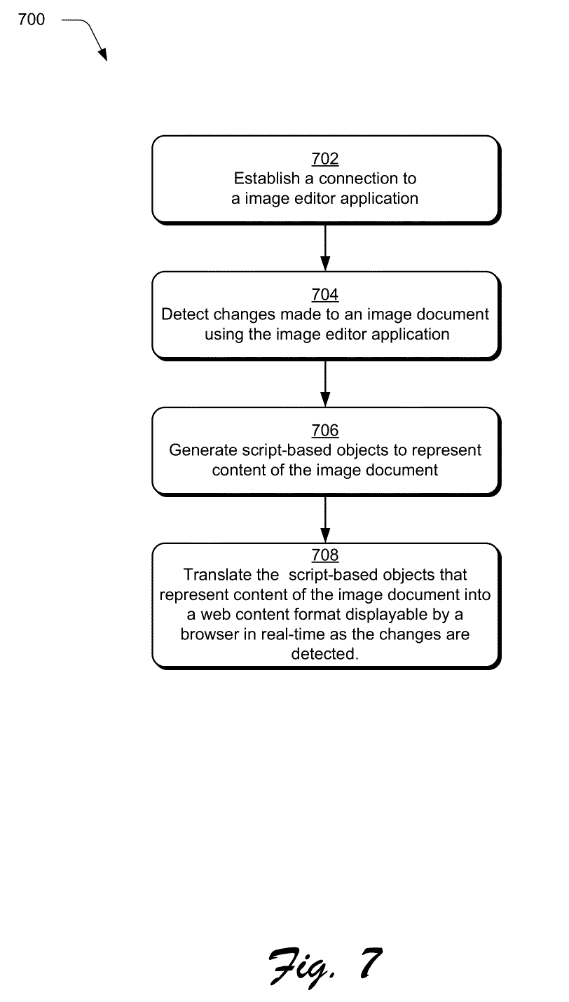

FIG. 7 depicts another example procedure 700 in which content of an image document is translated to a web content format. A connection is established to an image editor application (block 702). For example, an editor plugin associated with a generator module 118 may be employed to establish a communication connection between the generator module 118 and the image editor application as previously described. The image editor application may be Adobe Photoshop™ or other suitable image editing software. The connection may be a TCP/IP connection of a node.js server or another suitable connection. In at least some cases, the connection makes uses of a built-in application programming interface (API) of the image editor application designed to facilitate notifications regarding content/document changes, as well as other communications and actions.

Changes to an image document that are made using an image editor application are detected (block 704). Here, the generator module 118 may detect changes as the changes occur via the communication connection that is established. This may involve notifications that are sent by the image editor application when changes occur that the generator module 118 subscribes to or is otherwise able to obtain and process. Script-based objects are generated to represent the content of the image document (block 706). In response to detection of the changes, the generator module 118 may operate to create and or update a script-based representation of the content. The script-based representation may be used internally by the generator module 118 as an intermediate format used to handle conversions back and forth between source/target formats. JSON or another suitable intermediate format may be employed as discussed previously. The script-based objects that represent content of the image document are translated into a web content format displayable by a browser in real-time as the changes are detected (block 708). Here, the generator module 118 may include a browser plug-in that operates to handle translations between the selected intermediate format and a web content format that is supported by the browser, such as HTML5 or another comparable mark-up language or web-based format. Accordingly, the representation of the content as script-based objects may be converted to web content format that is suitable for the browser. In this manner, changes that are detected in relation to an image editor application that may employ an application-specific and/or proprietary format may be converted to a web content format compatible with a browser (or format for another selected target application). This process occurs substantially in real-time as the changes are being made/detected. Accordingly, the browser may present a real-time representation of edited content that reflects changes made via an underlying source application.

Having described example procedures in accordance with one or more implementations, consider now an example system and device that can be utilized to implement the various techniques described herein.

Example System and Device

FIG. 8 illustrates an example system generally at 800 that includes an example computing device 802 that is representative of one or more computing systems and/or devices that may implement the various techniques described herein. This is illustrated through inclusion of the generator module 118, which operates as described above. The computing device 802 may be, for example, a server of a service provider, a device associated with a client (e.g., a client device), an on-chip system, and/or any other suitable computing device or computing system.

The example computing device 802 is illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
obtaining a notification describing changes to content of a project edited using a source application;
creating an internal representation of the content in an intermediate format;
converting the internal representation of the content to output files in an output format for a target application; and
exposing the output files for rendering by the target application to present a real-time representation of the content as edited in the output format.

2. A method as described in claim 1, wherein the method is implemented by a generator module configured to employ:
an input plugin associated with the source application to establish a communication connection with the source application, register for notifications regarding changes to the project, and update the internal representation of the content in response to the notifications; and
an output plugin associated with the target application to perform conversions of the internal representation to the output files in the output format for the target application.

3. A method as described in claim 1, wherein the source application comprises an image editing application.

4. A method as described in claim 3, wherein the content is edited using an application-specific format associated with the image editing application.

5. A method as described in claim 1, wherein the target application comprises a web browser.

6. A method as described in claim 1, wherein the internal representation of the content in the intermediate format represents the edited content as Java Script Object Notation (JSON) objects.

7. A method as described in claim 1, wherein the output files comprise web pages and the output format comprises a mark-up language format.

8. A method as described in claim 1, wherein exposing the output files comprises associating the output files with a uniform resource locator (URL) that enables the target application to present the real-time representation of the content as edited.

9. A method as described in claim 1, wherein exposing the output files comprises uploading the output files to a network accessible storage location for web-based access.

10. A method as described in claim 1, further comprising:
detecting changes made to the output files via the target application;
updating the internal representation to reflect the detected changes; and
converting the internal representation to a source format associated with the source application to enable presentation of a real-time representation of the changes in the source format via the source application.

11. One or more computer-readable storage media comprising instructions that are stored thereon that, responsive to execution by a computing device, cause the computing device to implement a generator module to perform operations including:
establishing a communication connection to an image editor application to register for notifications regarding changes made to an image document for the image editor application;
detecting changes made to the image document using the image editor application based on notifications from the image editor application;
generating script-based objects to represent content of the image document; and
translating the script-based objects that represent the content of the image document into a web content format displayable by a browser in real-time as the changes are detected.

12. One or more computer-readable storage media as described in claim 11, wherein the generator module comprises a node.js server.

13. One or more computer-readable storage media as described in claim 12, wherein communication connection comprise a Transmission Control Protocol/Internet Protocol (TCP/IP) connection of the node.js server to an application programming interface (API) of the image editor application to enable the notifications.

14. One or more computer-readable storage media as described in claim 11, wherein the instructions further cause the generator module to store the image document as translated into the web content format in association with a uniform resource locator (URL) navigable by the browser to display a representation of the image document with the detected changes substantially in real-time.

15. One or more computer-readable storage media as described in claim 11, wherein the web content format comprises an HTML5 representation of the image document that reflects the detected changes.

16. One or more computer-readable storage media as described in claim 11, wherein the generator module comprises:
a editor plugin associated with the image editor application configured to handle conversions to and from an application-specific format of the image editor application; and
a browser plugin associated with the browser to handle translations to and from the web content format displayable by the browser.

17. A computing device comprising:
a processing system;
one or more computer readable media storing instructions executable via the processing system to perform operations comprising:
detecting changes made to an image document using an image editor application that employs a proprietary document format;
updating script-based objects created to represent content of the image document to reflect the detected changes;
converting the script-based objects into output files having an HTML5 format renderable by a browser; and
storing the output files at a location accessible by the browser to enable rendering of a real-time HTML5 representation of the image document via the browser that includes the detected changes.

18. The computing device as described in claim 17, wherein the location accessible by the browser comprises a uniform resource locator (URL) associated with the image document to which the browser navigates to render the real-time HTML5 representation of the image document.

19. The computing device as described in claim 17, wherein the location accessible by the browser is associated with an online collaborative session with a collaboration service.

20. The computing device as described in claim 17, wherein the image document comprises a composite document that includes content corresponding to multiple source applications and updating the script-based objects comprises individually updating content associated with each of the multiple source applications.
